(19) United States
(12) Patent Application Publication
(10) Pub. No.: US 2024/0153333 A1
(43) Pub. Date: May 9, 2024

(54) SYSTEMS AND METHODS FOR PERFORMING A BALLOT-LEVEL COMPARISON RISK-LIMITING AUDIT WHILE ENSURING VOTER PRIVACY

(71) Applicant: Philip B. Stark, Berkeley, CA (US)

(72) Inventor: Philip B. Stark, Berkeley, CA (US)

(21) Appl. No.: 18/505,109

(22) Filed: Nov. 8, 2023

Related U.S. Application Data
(60) Provisional application No. 63/382,869, filed on Nov. 8, 2022.

(51) Int. Cl. G07C 13/00

(52) U.S. Cl. CPC G07C 13/00; G06Q 2230/00

(57) ABSTRACT

Systems and methods are provided for performing a risk-measuring or risk-limiting audit of reported winner(s) from among two or more candidates or of a reported outcome of ballot measure(s) in one or more contests of an election based on one or more social choice functions from a plurality of ballot cards.

### CROSS-REFERENCE TO RELATED APPLICATION

This application claims the benefit of U.S. Provisional Patent Application 63/382,869, filed Nov. 8, 2022, which is hereby incorporated by reference in its entirety.

### BACKGROUND

This disclosure relates to systems and methods for performing a ballot-level comparison risk-limiting audit while maintaining voter anonymity.

### SUMMARY OF THE INVENTION

Risk-measuring audits are used to confirm that reported election winner(s) or outcomes in one or more contests in an election match the selections of voters. Risk-limiting audits (RLAs) correct incorrect reported election outcomes or confirm that reported election outcomes are in fact correct. Ballot-level comparison audits (BLCAs) are a type of RLA which compare an interpretation of a randomly-selected cast-vote record (CVR) from an electronic voting system to a human interpretation of the corresponding cast ballot card. Matching CVRs to their corresponding cast ballot cards comes with its own set of challenges, such as ensuring voter privacy and time efficiency.

One approach to matching CVRs to their corresponding cast ballot card involves keeping ballot cards in the same order in which they were scanned so that the order of the CVRs matches the order of the cast ballot cards. Another approach involves imprinting or marking identifiers, such as serial numbers, on cast ballot cards after voters have turned them in but before scanning the ballot cards to generate CVRs. However, both of these approaches could compromise voter privacy when ballots are scanned in precincts as opposed to in vote centers or using central scanning. For example, one could keep track of the order of voters and conclude that a given voter was, e.g., the 17^{th} voter to cast a ballot, thus the 17^{th} CVR voting selection corresponds to the given voter. Moreover, an insider could use the serial numbers to correlate the serial number of a cast ballot card with the respective CVR. In addition to these approaches potentially compromising voter privacy, the approaches can be time-consuming. Voting centers receive hundreds, if not thousands, of cast ballot cards for a given election or contest. Voter ballot retrieval and manual reading of voting selections for hundreds of ballots uses valuable time and resources.

Machines, however, may also prove untrustworthy. The machines that imprint or mark serial numbers on cast ballot cards may omit or reuse identifiers, or misreport the identifiers used. Duplicate identifiers become increasingly difficult to manually detect as the number of cast ballot cards increases, and electronically detecting duplicate identifiers entails trusting more hardware and software to identify and report duplicates, leading to the same trust problem as the imprinting machines.

To address these problems, a processing system comprising at least one processor for performing a ballot-level comparison risk-measuring audit of a reported winner(s) from one of more contests in an election among a plurality of candidates, or a reported outcome of a one or more ballot measure(s) in the contest while maintaining voter anonymity are described herein. In some embodiments, the processing system obtains the reported winner or reported outcome of the one of more contests in the election. The winner or outcome in these contests is based on a plurality of ballot cards; in some embodiments, each ballot card comprises a selection of one candidate of the plurality of candidates and/or a selection of an outcome of a ballot measure. The candidate or outcome with the most votes is the reported winner or results in the reported outcome of a ballot measure.

In some embodiments, the processing system obtains a reported winner from a plurality of candidates of an election. For example, a contest in an election between candidates Alice and Bob has a reported winner of Alice. The election is based on a plurality of cast ballot cards. For example, 100,000 ballots were cast in the contest between Alice and Bob. Each cast ballot card comprises an indication of a vote for either Alice or Bob. The processing system marks an identifier from a plurality of identifiers on a subset of each cast ballot card of the plurality of ballot cards, the intention being that the identifier is unique in the context of the subset of marker cast ballot cards. In some embodiments, the identifiers may be printed on the ballot cards or associated with them in some other way. In some embodiments, a pseudo-random number generator may be used to generate a plurality of unpredictable identifiers for use in marking the cast vote ballots. The ballot cards are marked after the last opportunity a voter has to view the cast ballot cards in order to maintain voter anonymity. For example, a machine prints the number 1234 on Jim's ballot.

In some embodiments, the processing system generates a plurality of cast vote records, each cast vote record intended to correspond to a cast ballot card, the intended correspondence being based on the identifier on the cast ballot card. Each cast vote record comprises a machine interpretation of all of selections by the voter indicated by the corresponding cast ballot card. For example, the cast vote record for Jim's ballot is intended to correspond to the cast ballot card marked with the number 1234 and to record the selections in one or more contests made on Jim's ballot. In some embodiments, the plurality of cast vote records are generated in response to scanning each marked cast ballot card of the plurality of ballot cards.

In some embodiments, the processing system reports the plurality of identifiers used to mark a subset of the cast ballot cards and the identifiers intended to correspond each cast vote record to a cast ballot card. In some embodiments, the identifiers may comprise identifiers on a batch or subset of cast ballot cards or cast ballot cards separated by precinct. From the plurality of identifiers, the processing system selects a random subset or random sequence identifiers. The subset of random subset or sequence of identifiers may depend on the method of audit.

In some embodiments, the processing system retrieves the plurality of cast ballot cards, each of which supposedly carries an identifier from the randomly selected subset or sequence. The plurality of cast ballot cards are retrieved from a system that is storing the plurality of cast ballot cards. In some embodiments, the plurality of cast ballot cards are retrieved by the same hardware that scanned the plurality of cast ballot cards. In some embodiments, the plurality of cast ballot cards are retrieved by software additionally implemented on the scanners.

In some embodiments, the processing system retrieves the plurality of cast vote records, each of which is intended to correspond to a cast ballot of the chose subset. The plurality of cast vote records are retrieved from a system that is storing the plurality of cast vote records. In some embodiments, the plurality of cast vote records are retrieved by the same software used to generate the plurality of cast vote records. In some embodiments, the plurality of cast vote records are retrieved by software additionally implemented on the scanners. In some embodiments, the processing system confirms that the voting indication or selections on a cast ballot card marked with the identifier matches the selections on the machine interpretation of the cast vote record thought to correspond to the cast ballot card.

A plurality of detected and undetected errors may occur in one or more of the marking, generating, reporting and/or retrieving steps. In some embodiments, the processing system includes means to ensure that the claimed risk limit or measure risk to be reported buy the audit is not less than the actual risk limit or measured risk of the audit the. In some embodiments, the means are designed to assume the most unfavorable result as to the reported winner(s) of the election or reported outcomes of the ballot measure(s). For example, in the case that the same identifier is printed in error on more than one cast ballot card, the corresponding, unidentifiable, cast vote record is assumed to have the least favorable outcome for the contest being audited. In some embodiments, mathematical procedures are implemented to assign the value of the least favorable outcome to the respective cast vote record.

In some embodiments the methods and systems of this disclosure comprise:
1. A method for performing a risk-measuring or risk-limiting audit of a reported winner or winners from among two or more candidates and/or a reported outcome of a ballot measure or ballot measures in one or more contests in an election based on one or more social choice functions from a plurality of ballot cards reflecting a choice or choices or preferences of voters expressed within an official record of the votes (‘cast ballot cards’), comprising:
   marking, by a processing system comprising at least one processor, an identifier from a plurality of identifiers on a subset of the cast ballot cards from the plurality of the cast ballot cards, the intention being that each identifier is unique within various subsets of the cast ballot cards;
   generating, by the processing system, a plurality of cast-vote records, wherein each cast-vote record of the plurality of cast-vote records is intended to correspond to a cast ballot card from the subset of the plurality of cast ballot cards, the intended correspondence being based on the identifier on the cast ballot card;
   reporting, by the processing system, the plurality of the identifiers used to mark the subset of the cast ballot cards and the identifiers intended to establish a one-to-one correspondence between cast-vote records and cast ballot cards within the plurality of cast ballot cards;
   determining, by the processing system, whether the number of the cast ballot cards of the subset is less than the number of the cast vote records that are intended to correspond to the subset for one or more contests or whether the number of a plurality of cast ballot cards is less than the number of a plurality of cast vote records for one or more contests; and if so ignoring, by the processing system, a subset of the plurality of cast-vote records such that applying the social choice function to the remaining plurality of cast-vote records does not change the reported winner(s) or outcome(s) of the contest being audited;
   determining, using the processing system, whether the number of the cast ballot cards of the subset is less than the number of the cast vote records that are intended to correspond to the subset for one or more contests or whether the number of a plurality of cast ballot cards is less than the number of a plurality of cast vote records in any contest under audit, and accounting for any differences in the audit in a manner that ensures that a claimed risk limit or a measured risk to be reported by the audit is not less than an actual risk limit or a measured risk of the audit;
   selecting, by the processing system, a random subset or random sequence of the plurality of the identifiers reported to have been used to mark the subset of cast ballot cards;
   retrieving, optionally by the processing system, the plurality of the cast ballot cards each of which supposedly carries an identifier from the randomly selected subset of identifiers from a system storing the plurality of cast ballot cards;
   retrieving, by the processing system, the plurality of cast-vote records each of which is intended to correspond to a cast ballot card from the retrieved plurality of cast ballot cards from a system storing the plurality of the cast-vote records;
   compensating for detected and undetected errors in one or more of the marking, generating, reporting, or retrieving steps, to ensure that the claimed risk limit or a measured risk to be reported by the audit is not less than an actual risk limit or a measured risk of the audit; and
   repeating part or all of the process multiple times as needed to complete the risk-measuring or risk-limiting audit.
2. The method of claim 1, wherein the risk-limiting or risk-measuring audit is a ballot-level comparison audit of the reported winner(s) of one or more contests and/or the reported outcome(s) of one or more ballot measure(s).
3. The method of claim 1, wherein the risk-limiting or risk-measuring audit is a batch-level comparison audit of the reported winner(s) of one or more contests and/or the reported outcome(s) of one or more ballot measure(s).
4. The method of claim 1, wherein the risk-limiting or risk-measuring audit is a ballot-polling audit of the reported winner(s) of one or more contests and/or the reported outcome(s) of one or more ballot measure(s).
5. The method of claim 1, wherein the risk-limiting or risk-measuring audit is a hybrid audit of the reported winner(s) of one or more contests and/or the reported outcome(s) of one or more ballot measure(s).
6. The method of claim 1, wherein the risk-limiting or risk-measuring audit uses the ONEAudit method;
7. The method of claim 1, wherein the marking, by the processing system, of the identifier on each cast ballot card of the subset of the plurality of cast ballot cards further comprises:
   selecting, by the processing system, a seed for a pseudo-random number generator;
   generating, by the pseudo-random number generator, a plurality of unpredictable identifiers; and
   marking, by the processing system, an identifier on each cast ballot card in the subset of the cast ballot cards from the plurality of the cast ballot cards, the intention being that the identifier is unique in the context of a subset of the cast ballot cards and that no cast ballot card or corresponding cast-vote record can be linked to a particular voter who cast that ballot card.
8. The method of claim 1, wherein the generating the plurality of cast-vote records further comprises:
   scanning, by the processing system, each cast ballot card of the subset of the cast ballot cards from the plurality of the cast ballot cards.
9. The method of claim 1, wherein each respective cast-vote record comprises a machine interpretation of the votes indicated on the corresponding cast ballot card.
10. The method of claim 1, further comprising:
   checking, optionally by the processing system, whether the identifier marked on a cast ballot card of the subset of the cast ballot cards from the plurality of the cast ballot cards that is returned by the system storing the plurality of cast ballot cards matches the identifier requested by the processing system.
11. The method of claim 1, further comprising:
   checking, by the processing system, whether the identifier used to associate a cast-vote record of the plurality of the cast-vote records to a cast ballot card that is returned by the system storing the plurality of cast-vote records matches the identifier requested by the processing system.
12. The method of claim 1, further comprising
   creating, by the processing system, one or more assorters; and
   confirming, by the processing system, that the mean of each assorter in one or more subsets of the assorters is greater than a threshold value, wherein the means of those subsets of the assorters being greater than the threshold implies that a reported outcome of one or more of the contest outcomes of the election is correct.
13. A system for performing a risk-measuring or risk-limiting audit of a reported winner or winners from among two or more candidates and/or of a reported outcome of a ballot measure or ballot measures in one or more contests in an election based on one or more social choice functions from a plurality of ballot cards reflecting the official record of the choice or choices or voters from the candidates or measures in the election (‘cast ballot cards’), comprising:
   a processing system comprising at least one processor;
   a non-transitory computer readable medium storing instructions which, when executed by the processing system, cause the processing system to:
      mark an identifier from a plurality of identifiers on a subset of the cast ballot cards from the plurality of the cast ballot cards, the intention being that each identifier is unique in the context of a subset of the cast ballot cards;
      generate a plurality of cast-vote records, wherein each cast-vote record of the plurality of cast-vote records is intended to correspond to a cast ballot card from the subset of the plurality of cast ballot cards, the intended correspondence being based on the identifier on the cast ballot card;
      report a plurality of the identifiers used to mark the subset of ballot cards and the corresponding cast-vote records;
      determine whether the number of the cast ballot cards of the subset is less than the number of the cast vote records that are intended to correspond to the subset for one or more contests or whether the number of a plurality of cast ballot cards is less than the number of a plurality of cast vote records for one or more contests; and ignore a subset of the plurality of cast-vote records such that applying the social choice function to the remaining plurality of cast-vote records does not change the reported winner(s) or outcome(s) of the contest being audited;
      determine using a processing system comprising at least one processor, whether the number of the cast ballot cards of the subset is less than the number of the cast vote records that are intended to correspond to the subset for one or more contests or whether the number of a plurality of cast ballot cards is less than the number of a plurality of cast vote records in any contest under audit, and account for any differences;
      select a random subset or random sequence of the plurality of the identifiers reported to having been used to mark the subset of cast ballot cards;
      retrieve the plurality of the cast ballot cards each of which supposedly carries an identifier from the randomly selected subset of identifiers from a system storing the plurality of cast ballot cards;
      retrieve the plurality of cast-vote records each of which is intended to correspond to a cast ballot card from the retrieved plurality of cast ballot cards from a system storing the plurality of the cast-vote records;
      compensate for detected and undetected errors in one or more of the marking, generating, reporting, or retrieving steps, to ensure that a claimed risk limit or a measured risk reported by the audit is not less than an actual risk limit or a measured risk of the audit; and
      repeat part or all of the process multiple times as needed to complete the risk-measuring or risk-limiting audit.
14. The system of claim 13, wherein the risk-limiting or risk-measuring audit is a ballot-level comparison audit of the reported winner(s) of one or more contests and/or of the reported outcome(s) of one or more ballot measures.
15. The system of claim 13, wherein the risk-limiting or risk-measuring audit is a batch-level comparison audit of the reported winner(s) of one or more contests and/or the reported outcome(s) of one or more ballot measure(s).
16. The system of claim 13, wherein the risk-limiting or risk-measuring audit is a ballot-polling audit of the reported winner(s) of one or more contests and/or the reported outcome(s) of one or more ballot measure(s).
17. The system of claim 13, wherein the risk-limiting or risk-measuring audit is a hybrid audit of the reported winner(s) of one or more contests or of the reported outcome(s) of a ballot measure(s).
18. The system of claim 13, wherein the risk-limiting or risk-measuring audit uses the ONEAudit method.
19. The system of claim 13, wherein the instructions, when executed by the processing system, further cause the processing system to mark the identifier on each cast ballot card of the subset of the plurality of cast ballot cards by:
   selecting a seed for a pseudo-random number generator;
   generating a plurality of unpredictable identifiers; and
   marking an identifier on each cast ballot card in the subset of the cast ballot cards from the plurality of the cast ballot cards, the intention being that the identifier is unique in the context of the subset of the cast ballot cards in such a way that no marked ballot card can be linked to a particular voter who cast that ballot card.
20. The system of claim 13, wherein the instructions, when executed by the processing system, further cause the processing system to generate the plurality of cast-vote records by:
   scanning, by the processing system, each cast ballot card of the subset of the cast ballot cards from the plurality of the cast ballot cards.
21. The system of claim 13, wherein each respective cast-vote record comprises a machine interpretation of the votes indicated on the corresponding cast ballot card.
22. The system of claim 13, wherein the instructions, when executed by the processing system, further cause the processing system to:
   check whether the identifier marked on a cast ballot card of the subset of the cast ballot cards from the plurality of the cast ballot cards that is returned by the system storing the plurality of cast ballot cards matches the identifier requested by the processing system.
23. The system of claim 13, wherein the instructions, when executed by the processing system, further cause the processing system to:
   create one or more assorters; and
   confirm, by the processing system, that the mean of each assorter in one or more subsets of the assorters is greater than a specified threshold value, wherein the means of the subsets of the assorters being greater than that threshold value implies that a reported outcome of one or more of the election contest outcomes is correct.

### DETAILED DESCRIPTION OF THE INVENTION

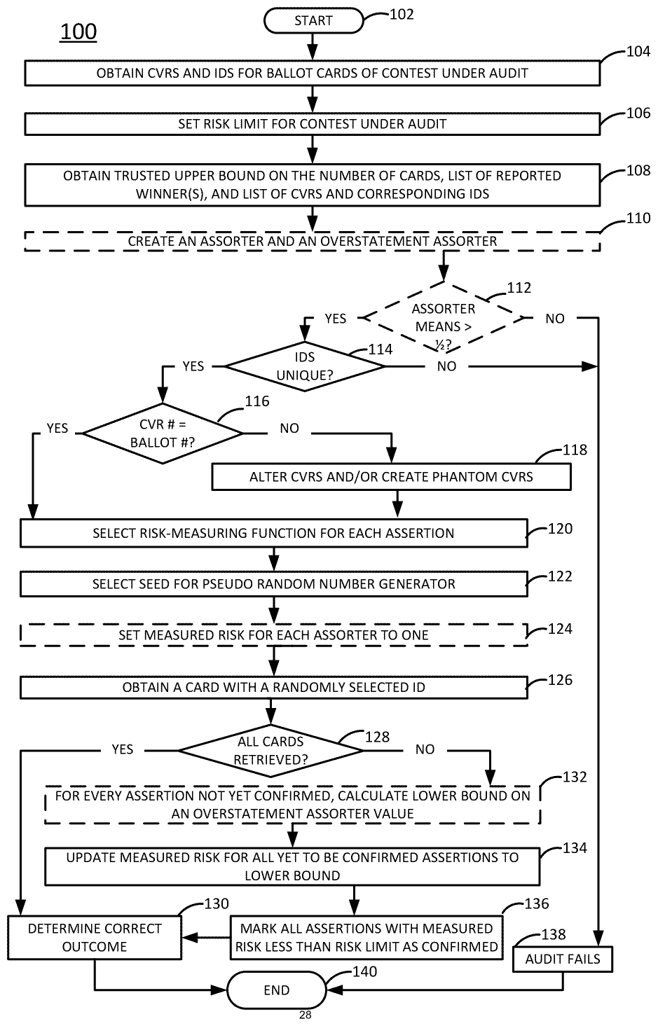

FIG. 1 illustrates one example of a method 100 for performing a risk-measuring audit, e.g., a ballot-level comparison risk-limiting audit, according to examples of the present disclosure. In one example, the method 100 may be performed by a processing system that is specially configured to perform the ballot-level comparison risk-limiting audit. In another example, the method may comprise instructions stored on a computer-readable storage medium. When executed by a processing system including at least one processor, the instructions may cause the processing system to perform the steps of the method 100.

The method 100 begins in step 102. The processing system may obtain a plurality of ballot cards for an election. In some embodiments, the processing system marks a unique identifier on each ballot card of the plurality of ballot cards. The unique identifier may be a serial number, a nonce, a QR code, a number generated by a pseudo-random number generator (PRNG), any other suitable identifier or combination thereof. It is assumed that the unique identifiers are immutable during the audit. When the unique identifier is a number generated by a PRNG, an unpredictable, undisclosed seed is randomly selected for the PRNG. The seed may be selected by public dice roll. In some embodiments, the seed includes entropy, generated locally or centrally, such that no person can link any unique identifier to any ballot card of the plurality of ballot cards. In some approaches, the identifiers are unique across all ballot cards, or the identifiers are unique within groups of ballot cards. For example, the ballot cards obtained in a particular precinct may unique identifiers. The unique identifier ensures voter anonymity and prevents coercion. In some embodiments, the unique identifier is printed on each ballot card of the plurality of ballot cards. The unique identifier may be printed on each ballot card before, during, or after each ballot card is scanned.

The processing system may generate a plurality of cast vote records (CVRs). Each CVR of the plurality of CVRs corresponds to a ballot card of the plurality of ballot cards and is associated with the same unique identifier as that of the corresponding ballot card. In some embodiments, the plurality of CVRs is generated by scanning the plurality of ballot cards. In step 104, the processing system may obtain a plurality of CVRs (each with a unique identifier) and a plurality of unique identifiers (possibly blank) for each ballot card associated with a contest under audit. In one example, a voting system has assigned the CVRs and unique identifiers and printed the identifiers on the cards.

In step 106, the processing system may set a risk limit for the contest under audit for risk-limiting audits. In one example, the risk limit is specified by a statute or rule of the jurisdiction in which the voting system is deployed, or by a human election administrator. For instance, in some states in the United States the risk limit is variously specified to be ten percent, five percent, or one percent.

In step 108, the processing system may obtain a trusted upper bound on the number of cards that contain the contest under audit, a list of the reported winner(s) of the contest under audit, and a list of the CVRs and corresponding unique identifiers for the cards (as committed to by the voting system).

In optional step 110 (illustrated in phantom), the processing system may create an assorter and an overstatement assorter for the contest under audit. Depending upon the type of the contest under audit and the number of candidates, a plurality of assorters may be created in step 110. For instance, to audit a plurality contest, the number of assorters created would be equal to the number of candidates minus one. For a multi-winner plurality contest, the number of assorters would be equal to the number of winners multiplied by a number equal to the number of candidates minus the number of winners. For a super-majority contest, the number of assorters would depend on whether the measure passed or failed. Thus, while step 110 involves the creation of at least one assorter, in practice step 110 will often involve the creation of a plurality of assorters.

It should be noted that step 110 is optional and represents only one example of conducting a risk limiting audit using a SHANGRLA approach. However, the examples disclosed herein could equally apply to other risk limiting audit techniques involving other functions of the CVRs and manually read votes.

In optional step 112 (illustrated in phantom), the processing system may determine whether the assorter means for the CVRs are all greater than one half. If the processing system concludes in step 112 that the assorter means for the CVRs are not all greater than one half (i.e., at least some assorter means are less than one half), then the method 100 may proceed to step 138, where the processing system may determine that the audit has failed. In other words, the processing system may conclude that, according to the CVRs, the reported winner(s) did not win. In this case, a full hand count of the ballots casted may be necessary. It is noted that in the case of an instant run-off vote (IRV), it is possible that a different set of sufficient assorters would all have means greater than one half.

If, however, the processing system concludes in step 112 that the assorter means for the CVRs are all greater than one half, then the method 100 may proceed to step 114. In step 114, the processing system may determine whether all of the unique identifiers associated with the CVRs (where both the CVRs and unique identifiers are obtained in step 108 as described above) are unique.

If the processing system concludes in step 114 that all of the unique identifiers associated with the CVRs are not unique (e.g., at least one ID is repeated), then the method 100 may proceed to step 138, where the processing system may determine that the audit has failed as described above.

If, however, the processing system concludes in step 114 that all of the unique identifiers associated with the CVRs are unique, then the method 100 may proceed to step 116. In step 116, the processing system may determine whether the number of CVRs that contain the contest under audit is equal to the number of ballot cards that contain the contest under audit (where both the list of CVRs and the trusted upper bound on the number of cards are obtained in step 108 as described above).

If the processing system concludes in step 116 that the number of CVRs that contain the contest under audit is not equal to the number of ballot cards that contain the contest under audit (e.g., there are either more CVRs than ballot cards or more ballot cards than CVRs), then the method 100 may proceed to step 118, where the processing system may alter the CVRs and/or create “phantom” CVRs, e.g., as discussed above in section 2.2.

The method 100 may then proceed to step 120. Alternatively, if the processing system concludes in step 116 that the number of CVRs that contain the contest under audit is equal to the number of ballot cards that contain the contest under audit, then the method 100 may proceed directly from step 116 to step 120, without performing step 118.

In step 120, the processing system may select the risk-measuring function for each assertion. In one example, the risk-measuring function is selected using ALPHA and a truncated shrinkage estimator.

In step 122, the processing system may select a seed for the audit's pseudorandom number generator (PRNG). In one example, the seed may be selected by public dice roll. In optional step 124 (illustrated in phantom), the processing system may set the measured risk for each assorter to one. In addition, the processing system may mark all assertions, as well as the contest, as “unconfirmed.” Steps 126-130 of the method 100, discussed in further detail below, may proceed while at least one of the assertions is marked as “unconfirmed.” In step 126, the processing system may obtain a card with a randomly selected unique identifier. In one example, the ID may be randomly selected from the CVRs and corresponding unique identifiers obtained in step 108. In one example, the randomly selected unique identifier may be denoted by ζ, while it may denote the index of the CVR cᵢ with the randomly selected unique identifier ζ. The processing system may request the card with the randomly selected unique identifier ζ from the voting system. If a card having the randomly selected unique identifier ζ has already been requested from and retrieved by the voting system (which may happen if the sample is drawn with replacement), then the previously retrieved card may be used going forward (i.e., without obtaining a new card).

It is noted that the processing system specifies or selects the unique identifiers of the ballot cards to be retrieved (although, as noted above, the unique identifiers are randomly selected). The processing system may then automatically retrieve the card marked with the selected unique identifier from the set of ballot cards associated with the contest under audit (e.g., by performing image processing and/or text recognition on the unique identifiers marked on the set of ballot cards), or may provide the unique identifier to a human auditor who may retrieve the card manually and provide the card to the processing system for analysis in accordance with the further steps of the method 100. In one example, step 126 may be performed in “batches,” i.e., by selecting a retrieving a plurality of cards at the same time.

In step 128, the processing system may determine whether all validly cast cards for the contest have been requested and retrieved (e.g., by comparing the retrieved cards to the list obtained in step 108). If the processing system concludes in step 128 that all validly cast cards for the contest have been requested and retrieved, then the method 100 may proceed to step 130. In step 130, the processing system may alert a human auditor to determine the correct outcome for the contest. At this point, the audit should have examined every validly cast card. All that is needed is to determine the correct contest outcome(s) on the basis of the reading of the validly cast cards, and to replace any incorrect reported outcomes with the correct outcomes.

It should be noted that in some cases, the human auditor(s) may decide to manually examine every (as yet unexamined) card cast in the contest, rather than continuing to sample cards at random. The contest outcomes according to that manual examination may then be used to correct any reported outcomes that the manual examination determines to be incorrect. If, however, the processing system concludes in step 128 that all validly cast cards for the contest have not been requested and retrieved, then the method 100 may proceed to step 132. In optional step 132 (illustrated in phantom), the processing system may, for every assertion A for the contest under audit that has not yet been confirmed, calculate a lower bound Lᵢ on the value that each overstatement assorter would have had, had the correct card been retrieved. If a card was retrieved with the randomly selected unique identifier ζ, step 132 may involve manually reading votes from the card. If no card was retrieved, or if a card with a different unique identifier other than the randomly selected ID ζ was retrieved, then the 122 calculation in step 132 may only involve the CVR cᵢ with the randomly selected unique identifier ζ.

In step 134, the processing system may update the measured risk for all yet to be confirmed assertions to the lower bound Lᵢ that was calculated in step 132. In step 136, the processing system may mark all assertions for which the measured risk (as updated in step 134) is less than the risk limit as “confirmed.” The method 100 may then proceed to step 130 as described above to alert the human auditor to determine the correct outcome of the contest.

Once the audit has either failed (e.g., in step 138) or alerted the human auditor to determine the correct outcome of the contest (e.g., in step 130), the method 100 may end in step 140. The method 100 therefore automates a plurality of audit steps that were not previously able to be reliably automated. For instance, conventional audit methods might utilize software to export CVRs from the voting system, to import CVRs from the voting system (possibly with serial numbers), to determine the size of an initial audit sample, to randomly select ballot cards to be audited, to perform calculations on the audit data to determine whether the “measured risk” is below a risk limit (so the audit can stop), to determine the number of additional ballots to inspect if the measured risk exceeds the risk limit, to select the additional ballots, and to report audit results.

The method 100 goes several steps further to reliably automate audit steps that have not previously been automated. These steps include: printing identifiers (e.g., nonces, serial numbers, human-readable text, human-readable text in a font that can be easily recognized using optical character recognition, barcodes, QR codes, or other identifiers) on ballot cards, importing CVRs together with the identifiers that identify the corresponding ballot cards (where the CVRs and identifiers may be exported by the voting system or may be part of the auditing system), creating “phantom” CVRs and deleting (or simply flagging without deleting) some CVRs (identified automatically) when the number of CVRs does not match the number of ballot cards for one or more contests under audit (where phantom CVRs may be stored or accounted for without being electronically created and stored), retrieving ballot cards identified with particular identifiers, and calculating values for use in subsequent risk calculations that depend on whether the system retrieves a ballot card (and, if so, whether the retrieved ballot card is in fact marked with the identifier requested). In particular, the disclosed modification of the data when a retrieved ballot card is not marked with a requested identifier ensures that the risk limit of the audit is still correct. However, it should be noted that some audit steps are not automated by the disclosed method, such as the step of reading the votes from the ballot cards selected for audit (which is done manually by one or more human auditors).

The method 100 works for a plurality of social choice functions used in elections, including, but not limited to: simple plurality, multi-winner plurality, super-majority, ranked-choice voting/instant runoff voting, D'Hondt, Hamilton, STAR-Voting, Borda count, approval voting, and all scoring rules.

Moreover, as noted above, although examples of the method 100 are discussed within the context of a risk limiting audit using a SHANGRLA approach, the examples disclosed herein could equally apply to other risk limiting audit techniques involving other functions of the CVRs and manually read votes. Thus, in general, the examples disclosed herein work for ballot-level comparison audits using any audit comparison method that is based on testing whether the net “overstatement error” of any margin according to the CVRs exceeds the margin. Such ballot-level comparison audits include, but are not limited to, SHANGRLA. For example, other ballot-level comparison audits that may benefit from the disclosed approach are described in Stark, P. B., 2009, “Risk-limiting post-election audits: P-values from common probability inequalities,” IEEE Transactions on Information Forensics and Security, 4, 1005-1014; Stark, P. B., 2010, “Super-simple simultaneous single-ballot risk-limiting audits. 2010 Electronic Voting Technology Workshop/Workshop on Trustworthy Elections (EVT/WOTE '10); Benaloh, J., D. Jones, E. Lazarus, M. Lindeman, and P. B. Stark, 2011, “SOBA: Secrecy-preserving Observable Ballot-level Audit,” 2011 Electronic Voting Technology Workshop/Workshop on Trustworthy Elections (EVT/WOTE '11); Lindeman, M. and P. B. Stark, 2012, “A Gentle Introduction to Risk-Limiting Audits,” IEEE Security & Privacy, 10, 42-49; Ottoboni, K., P. B. Stark, M. Lindeman, and N. McBurnett, 2018, “Risk-Limiting Audits by Stratified Union-Intersection Tests of Elections (SUITE),” Electronic Voting. E-Vote-ID 2018. Lecture Notes in Computer Science, Springer; and Benaloh, J., P. B. Stark, and V. J. Teague, 2019, “VAULT: Verifiable Audits Using Limited Transparency,” Proceedings of E-Vote ID 2019, Lecture Notes in Computer Science, 11759, R. Krimmer, M. Volkamer, V. Cortier, B. Beckert, R. Kusters, U. Serdult and D. Duenas-Cid (Eds.) Springer Nature, Switzerland.

Thus, in non-SHANGRLA examples, no assorters, overstatement assorters, or the like may be used. However, in such cases, certain aspects of the present disclosure will remain as described above. These aspects include: (1) a check to confirm that the number of CVRs is equal to the number of ballot cards (and an adjustment if the numbers are not equal); (2) a check to verify that the CVRs yield the same winners reported by the system; and (3) use of a returned ballot card as-is when the ID marked on the ballot card matches a requested unique identifier (or less favorable treatment of the returned ballot card when the unique identifier marked on the ballot card does not match the requested unique identifier or when the returned ballot card is not marked with any unique identifier at all).

Although not specifically specified, one or more steps, functions or operations of the method 100 may include a storing, displaying and/or outputting step as required for a particular application. In other words, any data, records, fields, and/or intermediate results discussed in the method 100 can be stored, displayed and/or outputted either on the device executing the method 100, or to another device, as required for a particular application. Furthermore, steps, blocks, functions, or operations in FIG. 1 that recite a determining operation or involve a decision do not necessarily require that both branches of the determining operation be practiced. In other words, one of the branches of the determining operation can be deemed as an optional step. In addition, one or more steps, blocks, functions, or operations of the above described method 100 may comprise optional steps, or can be combined, separated, and/or performed in a different order from that described. While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method for performing a risk-measuring or risk-limiting audit of a reported winner or winners from among two or more candidates and/or a reported outcome of a ballot measure or ballot measures in one or more contests in an election based on one or more social choice functions from a plurality of ballot cards reflecting a choice or choices or preferences of voters expressed within an official record of the votes (‘cast ballot cards’), comprising:
marking, by a processing system comprising at least one processor, an identifier from a plurality of identifiers on a subset of the cast ballot cards from the plurality of the cast ballot cards, the intention being that each identifier is unique within various subsets of the cast ballot cards;
generating, by the processing system, a plurality of cast-vote records, wherein each cast-vote record of the plurality of cast-vote records is intended to correspond to a cast ballot card from the subset of the plurality of cast ballot cards, the intended correspondence being based on the identifier on the cast ballot card;
reporting, by the processing system, the plurality of the identifiers used to mark the subset of the cast ballot cards and the identifiers intended to establish a one-to-one correspondence between cast-vote records and cast ballot cards within the plurality of cast ballot cards;
determining, by the processing system, whether the number of the cast ballot cards of the subset is less than the number of the cast vote records that are intended to correspond to the subset for one or more contests or whether the number of a plurality of cast ballot cards is less than the number of a plurality of cast vote records for one or more contests; and if so ignoring, by the processing system, a subset of the plurality of cast-vote records such that applying the social choice function to the remaining plurality of cast-vote records does not change the reported winner(s) or outcome(s) of the contest being audited;
determining, using the processing system, whether the number of the cast ballot cards of the subset is less than the number of the cast vote records that are intended to correspond to the subset for one or more contests or whether the number of a plurality of cast ballot cards is less than the number of a plurality of cast vote records in any contest under audit, and accounting for any differences in the audit in a manner that ensures that a claimed risk limit or a measured risk to be reported by the audit is not less than an actual risk limit or a measured risk of the audit;
selecting, by the processing system, a random subset or random sequence of the plurality of the identifiers reported to have been used to mark the subset of cast ballot cards;
retrieving, optionally by the processing system, the plurality of the cast ballot cards each of which supposedly carries an identifier from the randomly selected subset of identifiers from a system storing the plurality of cast ballot cards;
retrieving, by the processing system, the plurality of cast-vote records each of which is intended to correspond to a cast ballot card from the retrieved plurality of cast ballot cards from a system storing the plurality of the cast-vote records;
compensating for detected and undetected errors in one or more of the marking, generating, reporting, or retrieving steps, to ensure that the claimed risk limit or a measured risk to be reported by the audit is not less than an actual risk limit or a measured risk of the audit; and
repeating part or all of the process multiple times as needed to complete the risk-measuring or risk-limiting audit.

2. The method of claim 1, wherein the risk-limiting or risk-measuring audit is a ballot-level comparison audit of the reported winner(s) of one or more contests and/or the reported outcome(s) of one or more ballot measure(s).

3. The method of claim 1, wherein the risk-limiting or risk-measuring audit is a batch-level comparison audit of the reported winner(s) of one or more contests and/or the reported outcome(s) of one or more ballot measure(s).

4. The method of claim 1, wherein the risk-limiting or risk-measuring audit is a ballot-polling audit of the reported winner(s) of one or more contests and/or the reported outcome(s) of one or more ballot measure(s).

5. The method of claim 1, wherein the risk-limiting or risk-measuring audit is a hybrid audit of the reported winner(s) of one or more contests and/or the reported outcome(s) of one or more ballot measure(s).

6. The method of claim 1, wherein the risk-limiting or risk-measuring audit uses the ONEAudit method;

7. The method of claim 1, wherein the marking, by the processing system, of the identifier on each cast ballot card of the subset of the plurality of cast ballot cards further comprises:
selecting, by the processing system, a seed for a pseudo-random number generator;
generating, by the pseudo-random number generator, a plurality of unpredictable identifiers; and
marking, by the processing system, an identifier on each cast ballot card in the subset of the cast ballot cards from the plurality of the cast ballot cards, the intention being that the identifier is unique in the context of a subset of the cast ballot cards and that no cast ballot card or corresponding cast-vote record can be linked to a particular voter who cast that ballot card.

8. The method of claim 1, wherein the generating the plurality of cast-vote records further comprises:
scanning, by the processing system, each cast ballot card of the subset of the cast ballot cards from the plurality of the cast ballot cards.

9. The method of claim 1, wherein each respective cast-vote record comprises a machine interpretation of the votes indicated on the corresponding cast ballot card.

10. The method of claim 1, further comprising:
checking, optionally by the processing system, whether the identifier marked on a cast ballot card of the subset of the cast ballot cards from the plurality of the cast ballot cards that is returned by the system storing the plurality of cast ballot cards matches the identifier requested by the processing system.

11. The method of claim 1, further comprising:
checking, by the processing system, whether the identifier used to associate a cast-vote record of the plurality of the cast-vote records to a cast ballot card that is returned by the system storing the plurality of cast-vote records matches the identifier requested by the processing system.

12. The method of claim 1, further comprising
creating, by the processing system, one or more assorters; and
confirming, by the processing system, that the mean of each assorter in one or more subsets of the assorters is greater than a threshold value, wherein the means of those subsets of the assorters being greater than the threshold implies that a reported outcome of one or more of the contest outcomes of the election is correct.

13. A system for performing a risk-measuring or risk-limiting audit of a reported winner or winners from among two or more candidates and/or of a reported outcome of a ballot measure or ballot measures in one or more contests in an election based on one or more social choice functions from a plurality of ballot cards reflecting the official record of the choice or choices or voters from the candidates or measures in the election (‘cast ballot cards’), comprising:
a processing system comprising at least one processor;
a non-transitory computer readable medium storing instructions which, when executed by the processing system, cause the processing system to:
mark an identifier from a plurality of identifiers on a subset of the cast ballot cards from the plurality of the cast ballot cards, the intention being that each identifier is unique in the context of a subset of the cast ballot cards;
generate a plurality of cast-vote records, wherein each cast-vote record of the plurality of cast-vote records is intended to correspond to a cast ballot card from the subset of the plurality of cast ballot cards, the intended correspondence being based on the identifier on the cast ballot card;
report a plurality of the identifiers used to mark the subset of ballot cards and the corresponding cast-vote records;
determine whether the number of the cast ballot cards of the subset is less than the number of the cast vote records that are intended to correspond to the subset for one or more contests or whether the number of a plurality of cast ballot cards is less than the number of a plurality of cast vote records for one or more contests; and ignore a subset of the plurality of cast-vote records such that applying the social choice function to the remaining plurality of cast-vote records does not change the reported winner(s) or outcome(s) of the contest being audited;
determine using a processing system comprising at least one processor, whether the number of the cast ballot cards of the subset is less than the number of the cast vote records that are intended to correspond to the subset for one or more contests or whether the number of a plurality of cast ballot cards is less than the number of a plurality of cast vote records in any contest under audit, and account for any differences;
select a random subset or random sequence of the plurality of the identifiers reported to having been used to mark the subset of cast ballot cards;
retrieve the plurality of the cast ballot cards each of which supposedly carries an identifier from the randomly selected subset of identifiers from a system storing the plurality of cast ballot cards;
retrieve the plurality of cast-vote records each of which is intended to correspond to a cast ballot card from the retrieved plurality of cast ballot cards from a system storing the plurality of the cast-vote records;
compensate for detected and undetected errors in one or more of the marking, generating, reporting, or retrieving steps, to ensure that a claimed risk limit or a measured risk reported by the audit is not less than an actual risk limit or a measured risk of the audit; and
repeat part or all of the process multiple times as needed to complete the risk-measuring or risk-limiting audit.

14. The system of claim 13, wherein the risk-limiting or risk-measuring audit is a ballot-level comparison audit of the reported winner(s) of one or more contests and/or of the reported outcome(s) of one or more ballot measures.

15. The system of claim 13, wherein the risk-limiting or risk-measuring audit is a batch-level comparison audit of the reported winner(s) of one or more contests and/or the reported outcome(s) of one or more ballot measure(s).

16. The system of claim 13, wherein the risk-limiting or risk-measuring audit is a ballot-polling audit of the reported winner(s) of one or more contests and/or the reported outcome(s) of one or more ballot measure(s).

17. The system of claim 13, wherein the risk-limiting or risk-measuring audit is a hybrid audit of the reported winner(s) of one or more contests or of the reported outcome(s) of a ballot measure(s).

18. The system of claim 13, wherein the risk-limiting or risk-measuring audit uses the ONEAudit method.

19. The system of claim 13, wherein the instructions, when executed by the processing system, further cause the processing system to mark the identifier on each cast ballot card of the subset of the plurality of cast ballot cards by:
selecting a seed for a pseudo-random number generator;
generating a plurality of unpredictable identifiers; and
marking an identifier on each cast ballot card in the subset of the cast ballot cards from the plurality of the cast ballot cards, the intention being that the identifier is unique in the context of the subset of the cast ballot cards in such a way that no marked ballot card can be linked to a particular voter who cast that ballot card.

20. The system of claim 13, wherein the instructions, when executed by the processing system, further cause the processing system to generate the plurality of cast-vote records by:
scanning, by the processing system, each cast ballot card of the subset of the cast ballot cards from the plurality of the cast ballot cards.

21. The system of claim 13, wherein each respective cast-vote record comprises a machine interpretation of the votes indicated on the corresponding cast ballot card.

22. The system of claim 13, wherein the instructions, when executed by the processing system, further cause the processing system to:
check whether the identifier marked on a cast ballot card of the subset of the cast ballot cards from the plurality of the cast ballot cards that is returned by the system storing the plurality of cast ballot cards matches the identifier requested by the processing system.

23. The system of claim 13, wherein the instructions, when executed by the processing system, further cause the processing system to:
create one or more assorters; and
confirm, by the processing system, that the mean of each assorter in one or more subsets of the assorters is greater than a specified threshold value, wherein the means of the subsets of the assorters being greater than that threshold value implies that a reported outcome of one or more of the election contest outcomes is correct.
